(19) United States
(12) Patent Application Publication
(10) Pub. No.: US 2017/0244449 A1
(43) Pub. Date: Aug. 24, 2017

(54) PLUG CONNECTOR FOR CAPACITIVELY TRANSMITTING DATA

(71) Applicant: HARTING ELECTRONICS GMBH, Espelkamp (DE)

(72) Inventors: Guenter PAPE, Enger (DE); Jean-Merri DE VANSSAY, Paris (FR)

(21) Appl. No.: 15/519,801

(22) PCT Filed: Oct. 9, 2015
(86) PCT No.: PCT/EP2015/073427

§ 371 Date: Apr. 17, 2017

(30) Foreign Application Priority Data
Oct. 17, 2014 (DE) 102014115122.4

(51) Int. Cl. H04B 5/00

(52) U.S. Cl. CPC H04B 5/0031; H04B 5/0012

(57) ABSTRACT

Provided is a plug connector to which a multicore cable having at least two or more individual conductors can be connected, wherein the plug connector has at least one signal transmitter for contactless signal transmission, wherein the plug connector has a microchip, wherein the microchip can be electrically connected to the individual conductors and is electrically connected to the at least one signal transmitter. Also provided is a system including a plug connector and a mating connector, each of which having at least one signal transmitter, wherein the respective signal transmitters are aligned parallel to each other when mated.

The invention proceeds from a plug connector according to the preamble of independent claim 1. The invention likewise relates to a system comprising a plug connector and a mating connector.

Such plug connectors pass signals and/or data without the respective signal transmission means being in direct contact with each other. Such systems comprising a plug connector and a mating connector are specifically used when many mating cycles are to be achieved. The signal transmission elements are not subject to wear and tear.

### THE PRIOR ART

Signal transmission with the aid of signal transmission means that act inductively and/or capacitively is known from the prior art. DE 10 2010 045 742 A1 shows a coupling which comprises means, in this case coils, for inductive transmission of data signals.

However, the technique proposed there involves too large a structure to be used in smaller plug connectors. Small, compact plug connectors are often required in many applications.

### THE OBJECT OF THE INVENTION

The object of the invention is to provide a plug connector which performs well over a wide frequency range and which is simultaneously of compact design.

This object is achieved by the characterising features of independent claim 1.

Advantageous embodiments of the invention are described in the dependent claims.

A multicore cable having at least two or more individual conductors can be connected to the plug connector according to the invention. The plug connector has at least one signal transmission means which is provided for contactless signal transmission. In this case, contactless signal transmission means that there is no physical contact between the signal transmission means of a plug connector and of a mating connector which matches it. Contactless could also mean nothing more than that there is no electrically conductive connection between the signal transmission means.

The plug connector has a microchip which is connected to the one signal transmission means or to a plurality of several signal transmission means, and which can be electrically connected to the individual conductors of the connected cable.

The signal transmission means are preferably ring-shaped capacitors and/or parallel-plate capacitors. This allows a space-saving design. Any rotation between the plug connector and the mating connector is also made irrelevant by such signal transmission means. The signals are always transmitted equally well.

The microchip is an active microchip. The microchip needs a supply of power, which is fed through the incoming conductors, for example. However, a separate power supply, such as a battery, may also be provided in the plug connector itself. The microchip can process and pass on incoming signals by using a “multiplexing” technique, in which a plurality of incoming conductors and associated signals are transmitted through just one signal transmission element. In DE 10 2010 045 742 A1, each incoming conductor is assigned an inductive signal transmission means. In the case of a multicore cable, a plug connector would become very complex.

The microchip is also able to adjust the transmission power of the signal transmission means according to the distance between the plug connector and the mating connector.

This obviates the need to maintain an exact distance between the plug connector and the mating connector.

The active microchip makes it possible to cover a wide frequency range of binary signals, up to high data transfer rates in the megabit range, and to cover the associated frequencies.

Due to the active chip, there is no frequency-dependent attenuation in the transmission of signals or data, because capacitors which are actively driven (as data transfer means) do not show any low-pass, high-pass or band-pass behaviour. An actively driven capacitive coupling, such as the one proposed here, does not show any frequency-dependent attenuation, which opens up a wide range of uses for the plug connector.

The plug connector preferably has two signal transmission means. The one signal transmission means is provided for transmitting the signals coming into the plug connector via the connected cable. The other signal transmission means is provided for receiving the incoming signals from the mating plug. Thanks to the active microchip, the plug connector proposed here makes do with just two signal transmission means, which then allows the plug connector to be of simple and compact design.

It is preferable that one signal transmission means is in the form of a ring-shaped capacitor and the other signal transmission means is in the form of a circular capacitor plate. This geometry makes it possible to integrate the signal transmission means into the end face of the plug connector on the mating side.

The ring-shaped capacitor and the circular capacitor plate preferably have an equally large surface. The transmitting and receiving function of the plug connector according to the invention is optimised as a result.

The plug connector according to the invention is interference immune, because the signals and/or data are not transmitted by radio.

The plug connector has a plug connector housing, the end faces of which form a mating side and a wiring side. It is advantageous when the signal transmission means are completely enclosed by the mating side of the housing, or, expressed differently, when the signal transmission means and the capacitors described above are respectively arranged at the end face of the plug connector facing in the mating direction and are covered there with a plastic material. This is realised by an injection-moulding process, for example. The signal transmission means is protected against environmental influences as a result, which means that the plug connector can be used in dirty and harsh environments. In the unmated state, the individual plug connector is longitudinally watertight and is compliant with IP6x.

The signal transmission means is preferably aligned on the mating side parallel to the end face of the plug connector. This allows the plug connector and the mating connector to exchange signals and data in an optimal manner.

It is particularly advantageous when the plug connector has an insulating body having at least one conductor channel which is electrically connected on one side to the microchip and which can be electrically connected on the other side to a conductor of the connected cable. The at least one conductor channel is preferably produced using MID technology. The number of conductor channels is preferably matched to the number of incoming conductors of the multicore cable and of the signal transmission means. For that reason, a plurality of such conductor channels is generally provided. MID technology allows the plug connector to be of compact design.

A spring element, preferably a helical spring, is advantageously arranged in the plug connector housing in such a way that the spring force of the spring element presses the insulating body axially in the mating direction of the plug connector. The spring acts on one end face of the insulating body, with the result that the other end of the insulating body is pressed towards the mating side of the plug connector housing and rests tightly against the latter. As already described in the foregoing, this end face also has the signal transmission means.

Ideally, the respective signal transmission means are aligned parallel to each other when mated. Signal and data transmission work best when that is the case.

The invention also relates to a system comprising a plug connector and a mating connector, each of which having at least one signal transmission means, wherein the respective signal transmission means are aligned parallel to each other when mated.

The signal transmission means are preferably spaced 1.1 millimetres (mm) or less apart from each other when mated. This distance allows good signal and data transmission.

The plug connector and/or the mating connector of the system are ideally embodied in the same way as the claimed plug connector according to the invention. The plug connector and the mating connector may also be identical in construction. In the following, the plug connector and the mating connector are also referred to as plugs.

The plug connector and the mating connector are preferably connected to one other by a “push-pull connection”. A push-pull connection is ideal in the case of high-frequency applications, especially, due to the high level of protection against vibration that is provided. The hermaphroditic design of the insulating body of the plug connector and the mating plug allows a push-pull connection to be achieved in a particularly simple manner. There is no need to ensure that the mating faces are specially oriented in relation to each other within the rotational axis.

However, it is also conceivable that a screw connection, a bayonet lock, a locking mechanism using interlocking straps, or the like, is provided. The hermaphroditic design of the plug connector and the mating plug allows many different solutions here.

The hermaphroditic design also obviates the need to provide the plug connector with mechanical polarisation means.

The plug connector proposed here allows high mating tolerances. Any different distance between the signal transmission means can be compensated by the active chip.

A system operated with a plug connector according to the invention always has “galvanic separation”, because the signal transmission means of the plug connector and the mating plug or socket have no physical contact with each other.

### EMBODIMENTS OF THE INVENTION

Embodiments of the invention are shown in the drawings and shall be described in further detail below.

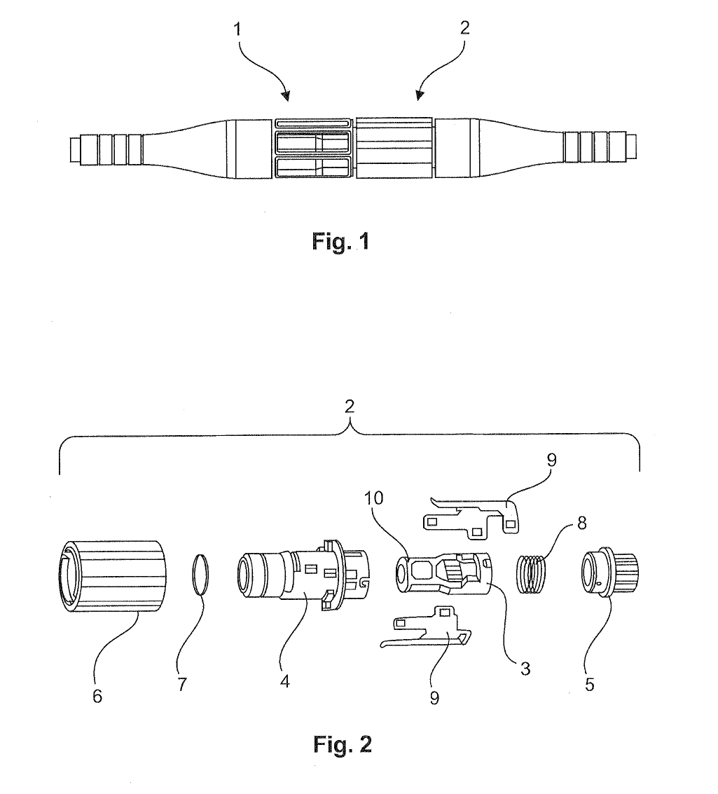

FIG. 1 shows a side view of a system comprising a plug connector and a mating connector,

FIG. 2 shows a perspective view with an exploded drawing of the mating connector,

FIG. 3 shows a perspective view with an exploded drawing of the plug connector,

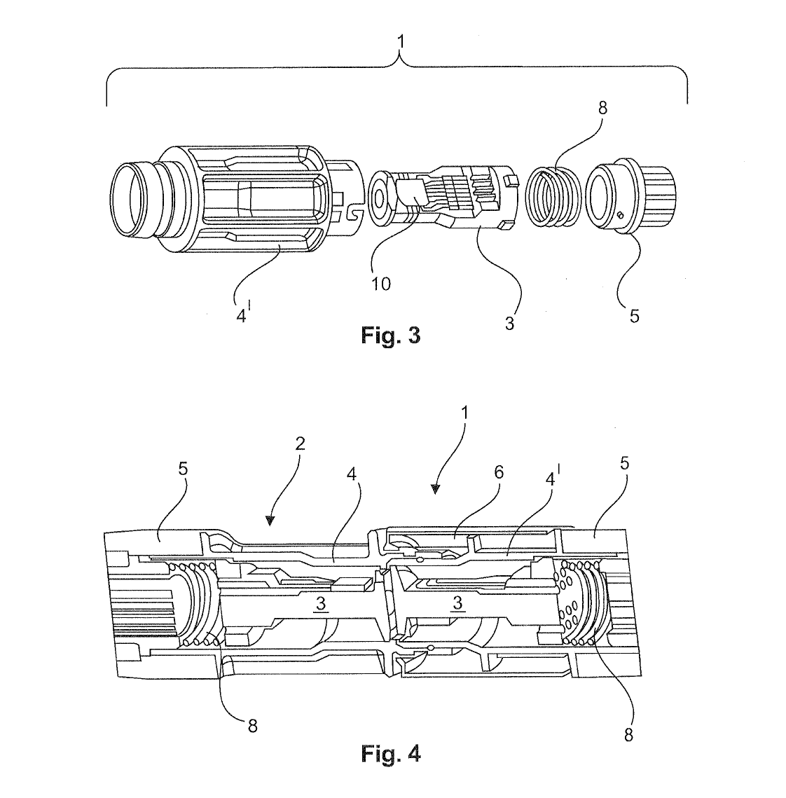

FIG. 4 shows a perspective cross-sectional view of the system comprising a plug connector and a mating connector,

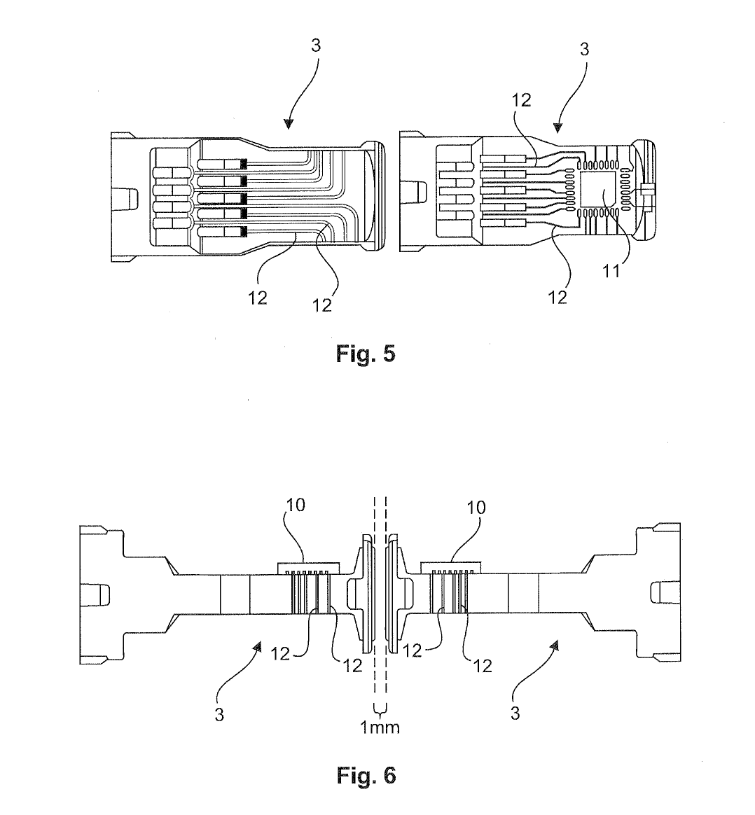

FIG. 5 shows a plan view of an insulating body of the plug connector and/or of the mating connector onto the upper side and onto the underside,

FIG. 6 shows a side view of the insulating body of the plug connector and/or the mating connector,

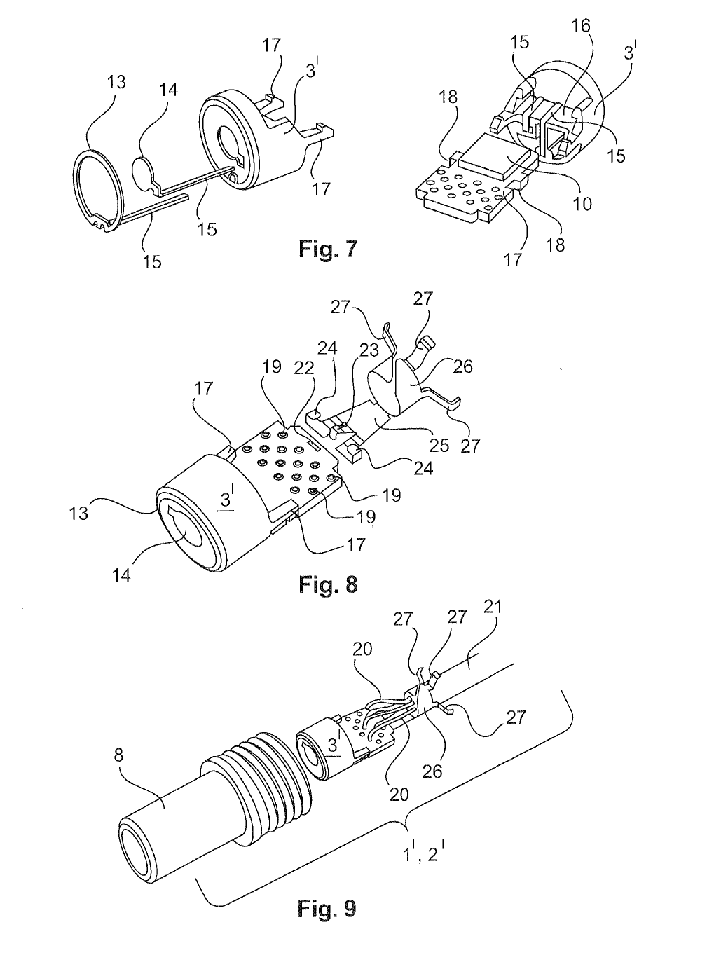

FIG. 7 shows another embodiment of a plug connector according to the invention, and specifically a perspective view of a mating portion of the plug connector,

FIG. 8 shows a perspective view of the mating portion of the plug connector with cable strain relief,

FIG. 9 shows a perspective view of another plug connector and/or mating connector with a cable connected thereto,

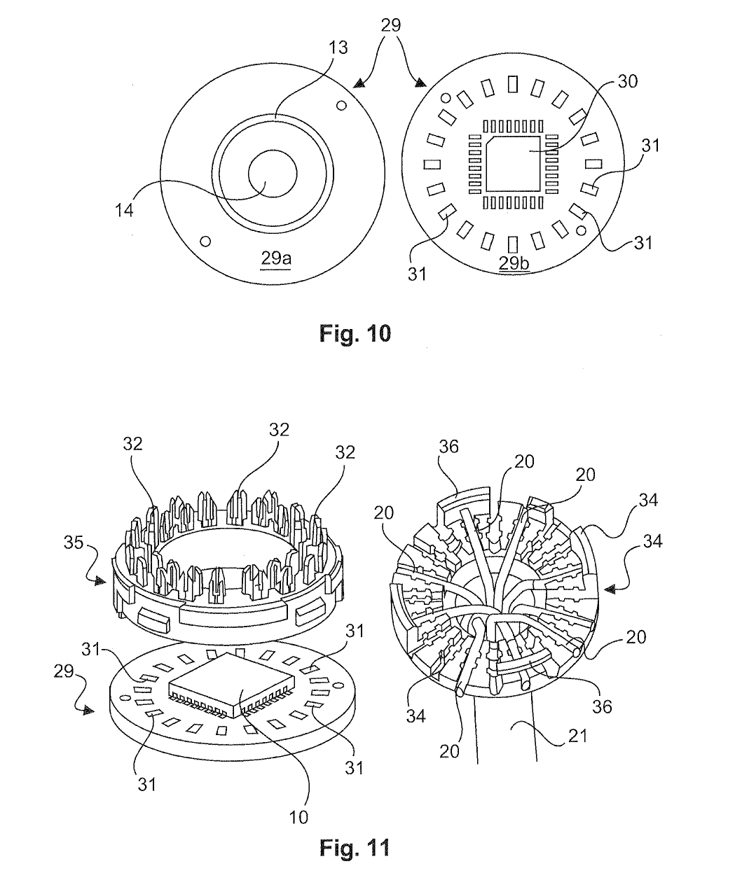

FIG. 10 shows another embodiment of a plug connector according to the invention, and specifically a view of the two sides of a circuit board,

FIG. 11 shows a perspective view of components forming an insulating body of the plug connector,

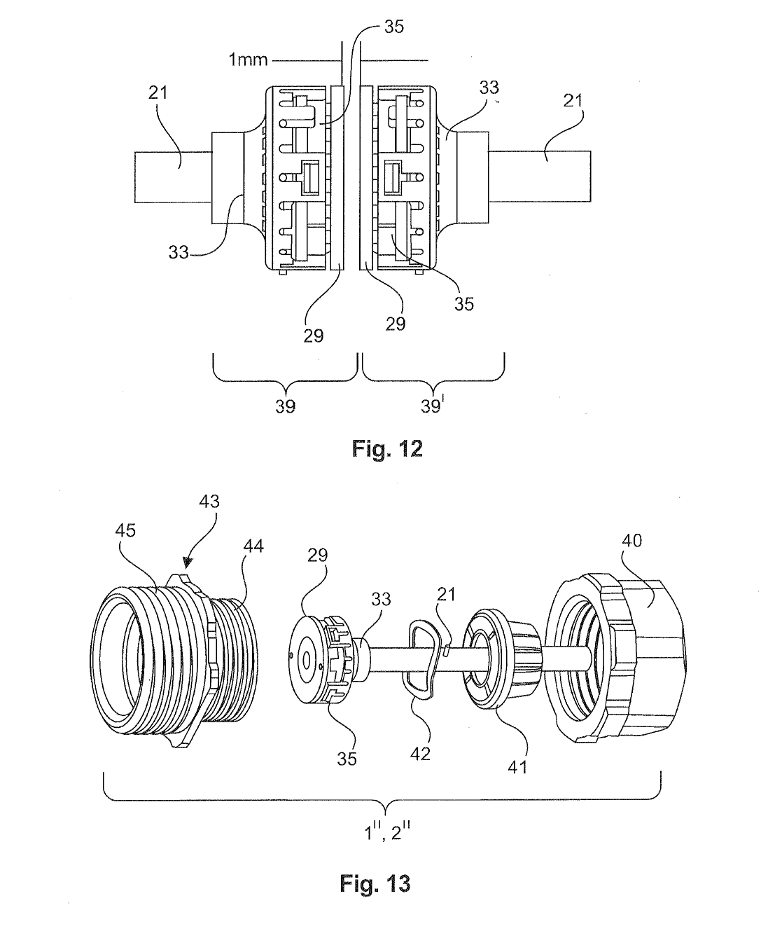

FIG. 12 shows a side view of the insulating bodies of the plug connector and the mating connector,

FIG. 13 shows a perspective view with an exploded drawing of the third embodiment of the plug connector,

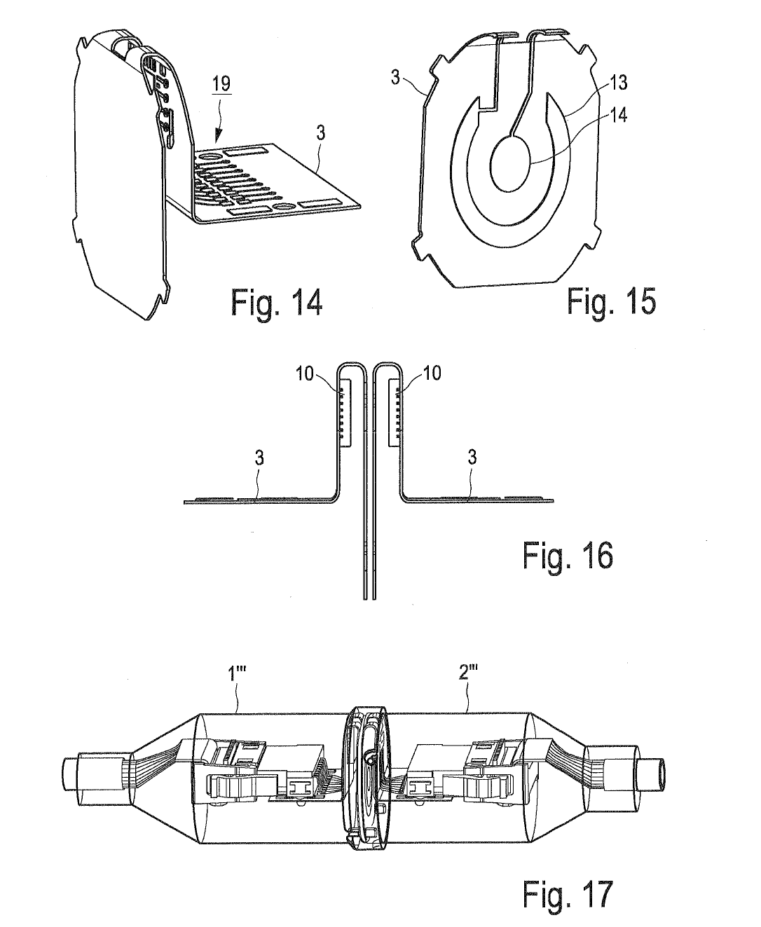

FIG. 14 shows a perspective view of an insulating body of a fourth embodiment,

FIG. 15 shows a partial view, from a different perspective, of the insulating body in FIG. 14, comprising two signal transmission means,

FIG. 16 shows a side view of two insulating bodies facing each other, in accordance with the fourth embodiment,

FIG. 17 shows a view of the plug connector and mating connector of the fourth embodiment,

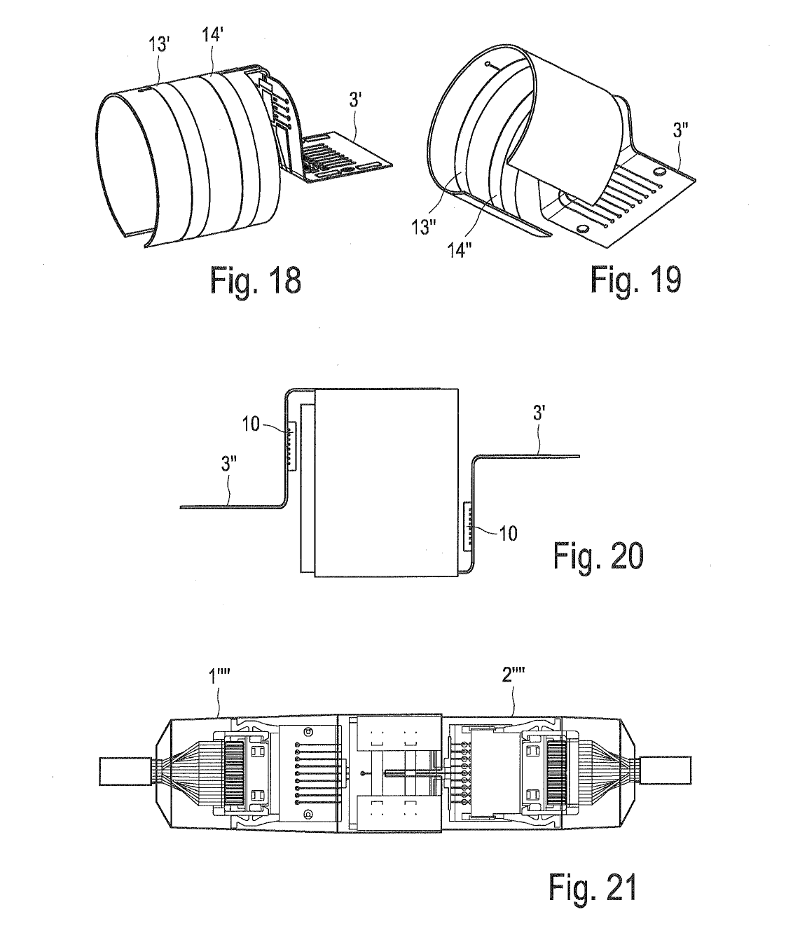

FIG. 18 shows a perspective view of an insulating body according to a fifth embodiment,

FIG. 19 shows a perspective view of another insulating body in the fifth embodiment;

FIG. 20 shows a side view of two insulating bodies facing each other, in accordance with the fifth embodiment,

FIG. 21 shows a view of the plug connector and the mating connector of the fifth embodiment,

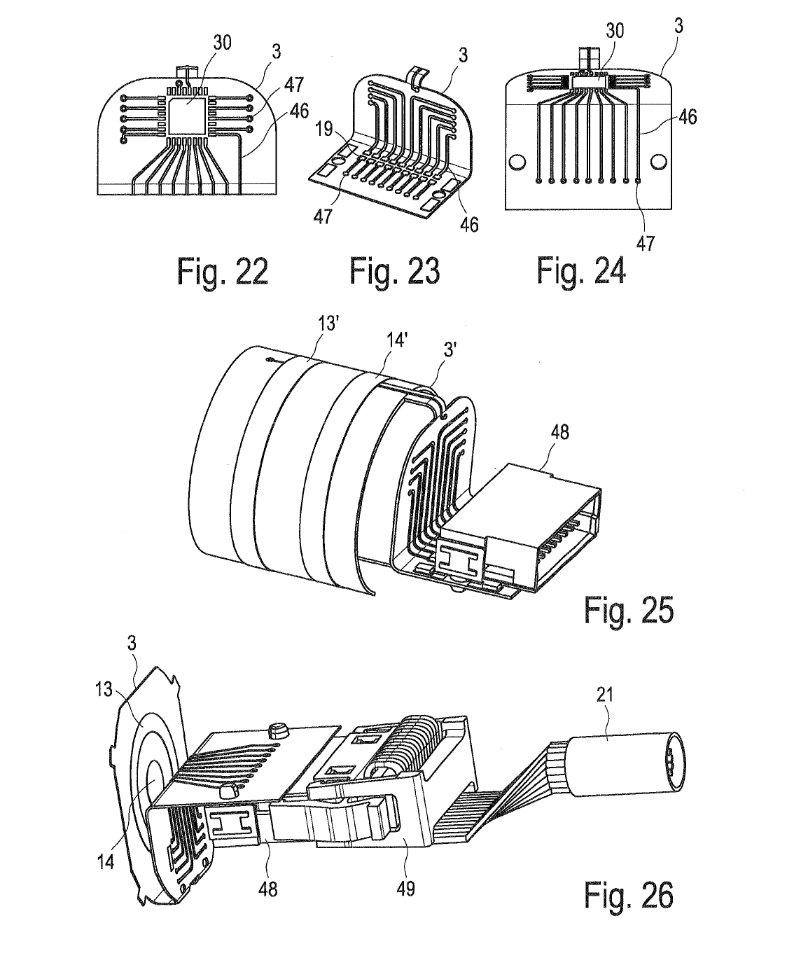

FIGS. 22-24 show partial views of an insulating body according to the fourth or fifth embodiment,

FIG. 25 shows a perspective view of an insulating body according to the fifth embodiment, with a cable connector attached thereto,

FIG. 26 shows a perspective view of an insulating body according to the fourth embodiment, with a cable connector and a cable connected thereto,

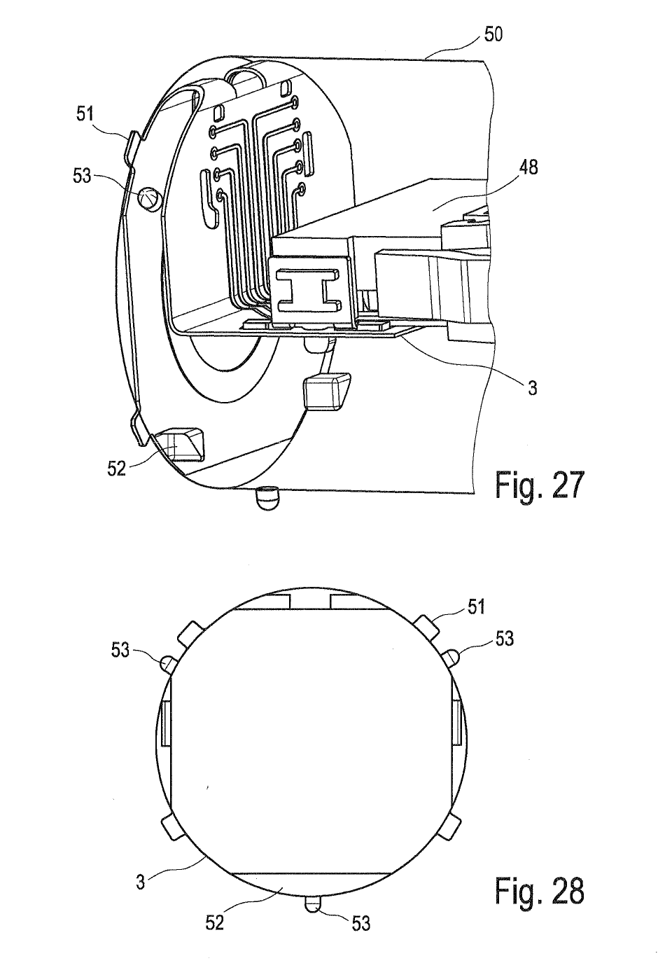

FIGS. 27 and 28 show views illustrating embedding of the insulating body of the fourth embodiment,

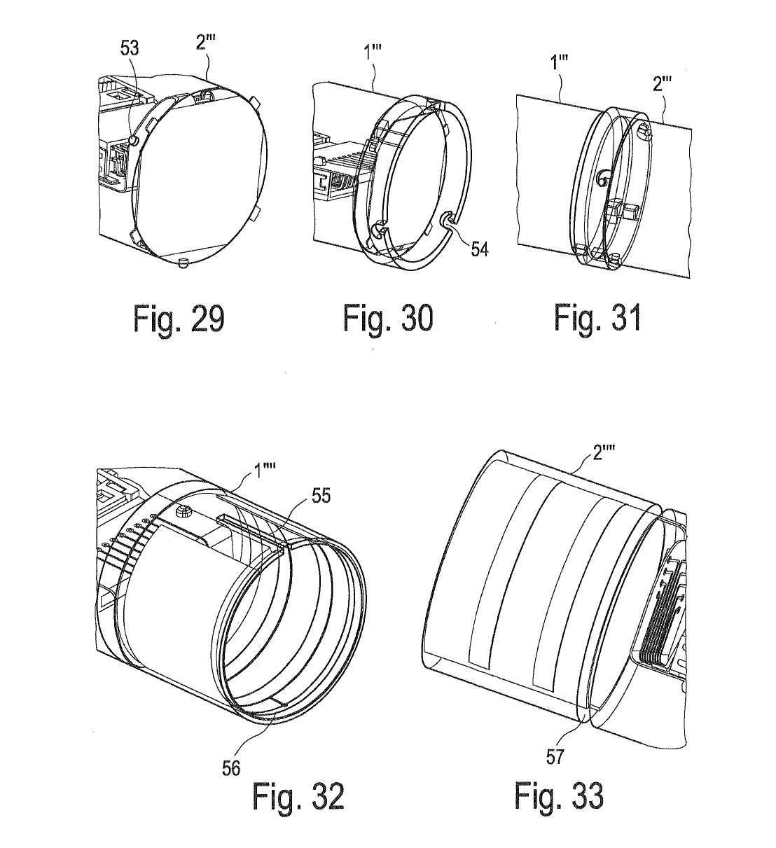

FIGS. 29, 30 and 31 show perspective views of the plug connector and the mating connector of the fourth embodiment, and

FIGS. 32 and 33 show perspective yews of the plug connector and the mating connector of the fifth embodiment.

The Figures contain partly simplified, schematic views. In some cases, identical reference signs are used for elements that are the same, but not necessarily identical. Different views of the same elements may be drawn to different scales.

### FIRST EMBODIMENT

FIG. 1 shows a plug connector 1 which is connected to (mated with) a matching mating connector 2 for signal transmission. The plug connector and mating connector shown here are provided for contactless signal transmission. Signals are transmitted here by substantially capacitive means, although inductive components may always play a role as well, of course. However, the latter play an insignificant role here, if any. The invention explicitly avoids the signal transmission means having any antenna function, so as to ensure, infer alia, that the signals/data are secure against eavesdropping.

In FIG. 2, an exploded drawing of mating connector 2 can be seen. Mating connector 2 consists of an insulating body, a housing 4, a cable outlet 5 and a screw-on sleeve 6. The mating region of mating connector 2 is sealed by a sealing ring 7. Insulating body 3 is permanently pressed in the direction of the mating portion with the aid of a helical spring 8 which rests against cable outlet 5. This ensures that the end face of insulating body 3 relevant for signal transmission is disposed close to the mating region of mating connector 2. Screw-on sleeve 6 is fixed to housing 4 with the aid of fixing plate 9.

FIG. 3 shows a perspective view with an exploded drawing of plug connector 1. Parts having the same function are marked here with the same reference signs as in mating connector 2. Here, too, insulating body 3 is pressed in the mating direction by a helical spring 8. Housing 4 of plug connector 1 has an external thread which cooperates with an internal thread of screw-on sleeve 6 of mating connector 2 in such a way that the plugs (plug connector 1 and mating connector 2) are connected to each other and that the end faces of the respective insulating body 3 are aligned approximately parallel to each other and at a defined distance from each other.

The function of helical spring 8 can be seen well in cross-sectional FIG. 4. The two insulating bodies 3 are pressed towards the mating region of the respective plug 1, 2 as far as a stop member.

FIG. 5 shows the top side and the underside of insulating body 3, which is installed in the same way in plug connector 1 and in mating connector 2. Insulating body 3 has a plurality of individual conductor channels 12 which are realised using MID technology. This allows channels 12 to be guided in a very flexible manner, thus resulting in a small component (insulating body 3). Some conductor channels end at a place 11 which is provided for attachment of a microchip 10. Incoming or outgoing data signals can be processed in any way by microchip 10. Microchip 10 is able to pass on incoming signals using a multiplexing technique.

The positions adopted by the respective insulating body 3 of plugs 1, 2 when mated can be seen in FIG. 6. The end faces of insulating bodies 3 facing in the mating direction are aligned parallel to each other and are spaced 1 mm apart from each other. Extensive testing has shown that such spacing is ideal for capacitive data transmission. The conductors of a multicore cable may be connected to the opposite end face of insulating body 3. This is not shown, however, for presentation reasons.

### SECOND EMBODIMENT

FIGS. 7 to 9 show an alternative embodiment of a plug 1′, 2′ according to the invention. Two signal transmission means 13, 14 are incorporated in the end face of insulating body 3′. One signal transmission means 13 is ring-shaped and the other signal transmission means 14 is in the form of a circular plate. Both signal transmission means 13, 14 have the same surface dimensions and a connection member 15 projecting perpendicularly to the basic shape. Connection member 15 is bent over a fixing surface 16 in insulating body 3′ in order to fix antennae 13, 14 in place.

Plug 1′, 2′ has a conductor board 17 which has recesses 18. Insulating body 3′ has latching arms 17, which latch into recesses 18 in conductor board 17 in order to fix the latter to insulating body 3′.

A microchip 10, which is in electrical contact with signal transmission means 13, 14 and the conductors 20 connected thereto, is attached to the conductor board. Conductor board 17 has solder pads 19, so called, for providing a soldered connection with conductors 20 of a (multicore) cable 21.

Plug 1′, 2′ also has a fixing element 25. Fixing element 25 is connected on one side to conductor board 17. Clamping lugs 24 and a tongue 23 disposed therebetween are provided for that purpose on the fixing element, and the tongue engages with a recess 22 in conductor board 17.

The other side of fixing element 25 consists of a ring member 26 having fixing arms 27 which project radially therefrom and which are slightly bent at the ends and which are pressed onto the cable sheath of connected cable 21 in order to relieve the strain on the cable. The fixing element also serves as continuation of the sheath on the connected cable.

The housing of plug 1′, 2′ may be designed in different ways. The shape of the housing is not relevant for the invention, so only screw fitting 28 is shown in FIG. 9.

### THIRD EMBODIMENT

An elementary component of a third variant of plug connector 1 according to the invention can be seen in FIG. 10. The component is a circular circuit board 29.

As is well known, circuit boards consist of electrically insulating material with conductive strips bonded thereto (strip line). Fibre-reinforced plastic is commonly used as the insulating material. The conductive strips are mostly etched from a thin layer of copper. The components are soldered onto solder pads, so called.

The first side 29a of circuit board 29 comprises the signal transmission elements, which as described above are formed from a layer of copper. The second side 29b of circuit board 29 has an attachment point 30 for the microchip 10 that has already been mentioned several times in the foregoing. Solder pads 31, clamping points 31, or electrical contacting points 31 for insulation-displacement connectors 32 are also provided here. It is here that insulation-displacement connectors 32 are electrically contacted and mechanically fixed.

The components which collectively form the insulating body of plug connector 1 can be seen in FIG. 11. A cable manager substantially composed of a cylindrical plastic part can be seen. Retaining channels 34 are provided here, in which conductors 20 of the connected cable 21 can be clamped. There is also a ring-shaped contacting element 35 which has recesses into which insulation-displacement connectors 32 are inserted.

Cable manager 33 has fixing arms 36 with window-like apertures which cooperate with fixing webs 37 of contacting element 35 in such a way that these components 33, 34 are fixed to one another. Insulation-displacement connectors 32 and associated conductive strips of circuit board 29 (not shown) provide electrical contact between conductors 20 and microchip 10.

The combination of components shown in FIG. 11 forms insulating body 39 of plug connector 1″ and can be found with identical construction in the plug connector and also in the associated mating connector. FIG. 12 shows how the circuit boards of the plug connector and mating connector, including signal transmission means 13, 14, are oriented in relation to each other. They are aligned parallel to each other, and the distance between them is approximately 1 millimetre.

FIG. 12 shows the complete exploded drawing of the third plug connector variant 1″. On the cable side, plug connector 1″ consists of a screw head 40. A combined sealing and strain relief element 41 is positioned in screw head 40. A wave spring 42 is arranged between the sealing and strain relief element 41 and insulating body 29 and performs substantially the same function as helical spring 8, described above, of the first two embodiments of plug connector 1, 1′. A double screw head 43, the one thread 44 of which is provided on the mating side, can be joined to screw head 40. The opposite thread 45 is provided for fixing to a mating connector.

### FOURTH AND FIFTH EMBODIMENT

FIG. 14 shows a perspective view of an insulating body 3 according to a fourth embodiment of the invention. Insulating body 3 is in the form of a flexible circuit board which is folded back on itself and to that extent has a shape in the side view (see FIG. 16) that is substantially like a “T”. Solder pads 19 of insulating body 3 can also be seen in FIG. 14.

FIG. 15 shows a partial view, from a different perspective, of the insulating body in FIG. 14, comprising two signal transmission means.

As was also the case in FIG. 7 and FIG. 10 above, signal transmission means 13, 14 are substantially ring-shaped (signal transmission means 13) or circular (signal transmission means 14), the circular signal transmission means 14 being arranged concentrically with the substantially ring-shaped signal transmission means 13. Signal transmission means 13, 14 are arranged on the side of insulating body 3 which in FIG. 14 is opposite the perpendicularly arranged end portion that can be seen in the view presented.

FIG. 16 shows a side view of two insulating bodies facing each other, in accordance with the fourth embodiment. As could already be seen in FIG. 14, insulating bodies 3 each have a shape in the side view that is substantially like a letter “T”, with the respective insulating body 3 being folded back on itself in one half of the crossbeam of the “T”. In each of the folded regions, microchip 10 is arranged, which thus lies opposite signal transmission means 13, 14.

If the side surface that can be seen on the left of FIG. 14 forms the outer surface of the insulating body and ultimately of the plug connector, signal transmission means 13, 14 and microchip 10 on the inner side of the flexible circuit board are protected against the outside world by said surface.

FIG. 17 is a view of plug connector 1″′ and mating connector 2″′ of the fourth embodiment.

Further details that can be seen FIG. 17 shall now be described with reference to FIGS. 25, 26 and 29 to 31.

FIG. 18 is a perspective view of an insulating body 3 according to a fifth embodiment of the invention.

As was already the case in the fourth embodiment, insulating body 3′ is provided in the form of a flexible circuit board, insulating body 3′ shown in FIG. 18 having, instead of the folded region of the insulating body that can be seen in FIG. 14, for example, a substantially tubular region on which signal transmission means 13′ and 14′ bent in a ring shape and in the form of a strip are provided.

FIG. 18 shows a perspective view of another insulating body 3″ according to the fifth embodiment of the invention. Insulating body 3″ is substantially identical in its basic structure to insulating body 3′ shown in FIG. 18, but the signal transmission means 13″, 14″, likewise bent in a ring shape and in the form of a strip, are arranged on the inner side of the tubular part of insulating body 3″, whereas the signal transmission means 13′, 14′ of insulating body 3′ in FIG. 18 are located on the outer side of the tubular region.

FIG. 20 shows a side view of two insulating bodies 3′, 3″ facing each other, in accordance with the fifth embodiment. As can be seen from FIG. 20, insulating bodies 3′, 3″ shown in FIGS. 18 and 19 are configured to couple to each other, in the form of a male coupling member (see FIG. 18) and a female coupling member (see FIG. 19).

Signal transmission means 13′, 14′ and 13″, 14″ lie opposite one another, but without any direct contact being provided between them.

If the flexible circuit board forming insulating bodies 13′, 13″ is sufficiently thin, each of the two signal transmission means 13′, 13″, 14′, 14″ can also be arranged on the outer side or the inner side of the tubular part of insulating body 3′, 3″. If the flexible circuit board is sufficiently thin, this can also be reversed such that the female coupling member carries its signal transmission means on the outer side and the male coupling member carries its signal transmission means on the inner side.

Similarly to FIG. 16, the respective microchips 10 can be seen in FIG. 20 also, namely at the respective positions on insulating body 3′, 3″.

FIG. 21 shows a view of plug connector 1″″ and mating connector 2″″ of the fifth embodiment. Reference is made to FIGS. 25, 32 and 33 for further details.

FIGS. 22 to 24 each show partial views of an insulating body 3 according to the fourth or fifth embodiment.

Insulating body 3, which is provided in the form of a flexible circuit board, has conductive strips 46 on both sides, thus achieving space savings on the whole. To allow sufficient contacting, through holes 47 are provided so that a conductive strip 46 is connected to a corresponding conductive strip 46 on the opposite side of insulating body 3.

In FIG. 22, the attachment point 30 for microchip 10 can be seen, whereas in FIG. 23, solder pad 19 for connecting the conductors of the cable can be seen.

FIG. 25 shows a perspective view of an insulating body 3′ according to the fifth embodiment, with a cable connector 48 attached thereto.

One way of contacting solder pad 19 with the conductors of the cable (not shown here) is to attach a cable connector to those solder pads, for example, a H-Flex SMT connector, to which it is then possible to connect a mating cable connector to which the conductors of cable 21 are connected.

FIG. 26 shows a perspective view of an insulating body 3 according to the fourth embodiment, to which a cable connector 48, 49 with a cable 21 connected thereto is attached.

However, it is likewise possible to attach the conductors of the cable directly to the respective solder pad, the greater complexity of apparatus necessary for the production process being justified by savings in respect of the material costs of the cable connectors.

When cable 21 is attached directly or indirectly to insulating body 3, 3′, 3″ of the fourth or fifth embodiment, the cable and the insulating body can be jointly cast into a suitable material, so that a desired sealing of the entire arrangement can be achieved, thus providing protection against dampness or the like.

FIG. 27 and FIG. 28 are views illustrating embedding of the insulating body 3 of the fourth embodiment. In FIG. 27, insulating body 3 with cable connector 48 attached thereto can be seen, which is embedded in a moulding compound 50.

Insulating body 3 has retention lugs 51 which allow the end portion of insulating body 3 to be fixed in the desired manner for embedding, in particular in such a way that the insulating body is sufficiently parallel with the end surface.

It is possible in this regard to embed insulating body 3 either on one side or on both sides, and if embedded on one side, then the end portion of insulating body 3 is also the outer surface at the end face of the plug connector thus produced.

The recesses 52 which can likewise be seen in FIG. 27 result from providing respective wall projections in the mould, by means of which the end portion of insulating body 3 is pressed against the moulding surface.

The retention luges 51 of insulating body 3 can likewise be seen in FIG. 28.

As can also be seen from FIGS. 27 and 28, bayonet studs 53 are provided when forming the moulding compound.

FIGS. 29, 30 and 31 show perspective views of plug connector 1″′ and mating connector 2″′ according to the fourth embodiment. As already shown in FIGS. 27 and 28, mating connector 2″′ shown in FIG. 29 has bayonet studs 53, whereas the plug connector 1″′ shown in FIG. 30 has bayonet slots 54 on a matchingly projecting portion, into which bayonet studs 53 can engage in order to fix plug connector 1″′ and mating connector 2″′ to each other, as shown in FIG. 31.

FIG. 32 and FIG. 33 show perspective views of plug connector 1″″ and mating connector 2″″ according to the fifth embodiment.

The insulating body of plug connector 1″′ and the insulating body of mating connector 2″″ are each sealed in a suitable manner, the seal having a longitudinally extending slot in the case of plug connector 1″″, thus allowing a degree of flexibility regarding deformation to widen the ring-shaped region. In its end portion, plug connector 1″″ also has an annular projection which extends around the inner side.

As shown in FIG. 33, mating connector 2″″ accordingly an annular groove 57 at a corresponding position, with which annular projection 56 can be brought into engagement to fix plug connector 1″″ and mating connector 2″″ to each other to a certain degree.

List of reference signs

| | |
|---|---|
| 1 | Plug connector |
| 2 | Mating connector |
| 3 | Insulating body |
| 4 | Housing |
| 5 | Cable outlet |
| 6 | Screw-on sleeve |
| 7 | Seal |
| 8 | Helical spring |
| 9 | Fixing plate |
| 10 | Microchip |
| 11 | Space for chip 10 |
| 12 | Conductor channel |
| 13 | Signal transmission means |
| 14 | Signal transmission means |
| 15 | Connection member |
| 16 | Fixing surface |
| 17 | Conductor board |
| 18 | Recess |
| 19 | Solder pad |
| 20 | Conductor |
| 21 | Cable |
| 22 | Recess |
| 23 | Tongue |
| 24 | Clamping lug |
| 25 | Fixing element |
| 26 | Ring member |
| 27 | Fixing arm |
| 28 | Screw fitting |
| 29 | Circuit board |
| 29a | first side |
| 29b | second side |
| 30 | Attachment point for microchip 10 |
| 31 | Solder pad, clamping point or electrical contacting point |
| 32 | Insulation-displacement connector |
| 33 | Cable manager |
| 34 | Retaining channel |
| 35 | Contacting element |
| 36 | Fixing arm |
| 37 | Fixing web |
| 39 | Insulating body |
| 40 | Screw head |
| 41 | Sealing and strain relief element |
| 42 | Wave spring |
| 43 | Double screw head |
| 44 | Thread |
| 45 | Thread |
| 46 | Conductive strip |
| 47 | Through hole |
| 48 | Cable connector |
| 49 | Cable connector |
| 50 | Sealing compound |
| 51 | Retention lug |
| 52 | Recess |
| 53 | Bayonet stud |
| 54 | Bayonet slot |
| 55 | Slot |
| 56 | Annular projection |
| 57 | Annular groove |

1. A plug connector, to which a multicore cable having at least two or more individual conductors can be connected,
wherein the plug connector has at least one signal transmitter for contactless signal transmission,
wherein the plug connector has a microchip, wherein the microchip can be electrically connected to the individual conductors and is electrically connected to the at least one signal transmitter.

2. The plug connector according to claim 1, wherein
the plug connector has two signal transmitters.

3. The plug connector according to claim 2, wherein
one signal transmitter is in the form of a ring-shaped capacitor and the other signal transmitter is in the form of a circular capacitor plate.

4. The plug connector according to claim 3, wherein
the ring-shaped capacitor and the circular capacitor plate have an equally large surface.

5. The plug connector according to claim 1, wherein
the plug connector has a plug connector housing, wherein a mating side and a wiring side are formed at its end faces,
and the signal transmitters are completely enclosed by the mating side of the housing.

6. The plug connector according to claim 1, wherein
the signal transmitter is aligned on the mating side parallel to the end face of the plug connector.

7. The plug connector according to claim 1, wherein
the plug connector has an insulating body having at least one conductor channel which is electrically connected on one side to the microchip and which can be electrically connected on the other side to a conductor of the connected cable.

8. The plug connector according to claim 8, wherein
the at least one conductor channel is produced using MID technology.

9. The plug connector according to claim 1, wherein
a spring element, is arranged in the plug connector housing in such a way that the spring force of the spring element presses the insulating body axially in the mating direction of the plug connector.

10. A system comprising a plug connector and a mating connector, each of which having at least one signal transmitters, wherein
the respective signal transmitters are aligned parallel to each other when mated.

11. The system comprising a plug connector and a mating connector according to claim 10, wherein
the signal transmitters are spaced 1.1 millimetres (mm) or less apart from each other when mated.

12. The system comprising a plug connector and a mating connector according to claim 1, wherein
the plug connector and/or the mating connector is embodied according claim 1.

13. The system comprising a plug connector and a mating connector according to claim 1, wherein
the plug connector and the mating connector are connected to one other by a push-pull locking mechanism.

14. The plug connector according to claim 9, wherein the spring element is a helical spring.
